(19) United States
(12) Patent Application Publication
(10) Pub. No.: US 2026/0061801 A1
(43) Pub. Date: Mar. 5, 2026

(54) CONTROL SYSTEM, CONTROL APPARATUS, AND CONTROL METHOD

(71) Applicant: TOYOTA JIDOSHA KABUSHIKI KAISHA, Toyota-shi (JP)

(72) Inventor: Mina MIZUNO, Nagoya-shi (JP)

(73) Assignee: TOYOTA JIDOSHA KABUSHIKI KAISHA, Toyota-shi (JP)

(21) Appl. No.: 19/261,037

(22) Filed: Jul. 7, 2025

(30) Foreign Application Priority Data
Sep. 5, 2024 (JP) 2024-153454

(51) Int. Cl. B60H 1/00

(52) U.S. Cl. CPC B60H 1/00742; B60H 1/00657

(57) ABSTRACT

A control apparatus includes a controller configured to check whether at least one passenger boarding a mobile object has a sign of infection of a predetermined infectious disease based on biological information of the at least one passenger that has been received from a wearable terminal worn by the at least one passenger, identify a position of a seat for a suspected infected person for whom the sign has been detected among the at least one passenger, and control air conditioning at the identified position of the seat.

### CROSS-REFERENCE TO RELATED APPLICATION

This application claims priority to Japanese Patent Application No. 2024-153454 filed on Sep. 5, 2024, the entire contents of which are incorporated herein by reference.

### TECHNICAL FIELD

The present disclosure relates to a control system, a control apparatus, and a control method.

### BACKGROUND

Technology related to the control of vehicle air conditioning is known. For example, Patent Literature (PTL) 1 discloses technology for reducing air conditioning interference between seats by adjusting the airflow generated from the air conditioning outlet of each seat and making the airflow at the edge of the seat stronger, so that the strong airflow acts as an air curtain.

### CITATION LIST

### Patent Literature

PTL 1: JP 2020-131743 A

### SUMMARY

However, technology according to PTL 1 is intended for individual temperature control by each passenger, and does not take into consideration the prevention of infections in the vehicle if the passenger is suffering from infectious diseases or other illnesses. Therefore, there is room for improvement with respect to technology related to the control of vehicle air conditioning.

It would be helpful to improve technology related to the control of vehicle air conditioning.

A control system according to an embodiment of the present disclosure includes:
a wearable terminal to be worn by at least one passenger boarding a mobile object, the wearable terminal being configured to:
measure biological information of the at least one passenger using one or more built-in sensors; and
transmit the measured biological information to a control apparatus; and
the control apparatus configured to:
   check whether the at least one passenger has a sign of infection of a predetermined infectious disease based on the biological information of the at least one passenger, which has been received from the wearable terminal;
   identify a position of a seat for a suspected infected person for whom the sign has been detected among the at least one passenger; and control air conditioning at the identified position of the seat.

A control apparatus according to an embodiment of the present disclosure includes a controller configured to:
check whether at least one passenger boarding a mobile object has a sign of infection of a predetermined infectious disease based on biological information of the at least one passenger that has been received from a wearable terminal worn by the at least one passenger;
identify a position of a seat for a suspected infected person for whom the sign has been detected among the at least one passenger; and
control air conditioning at the identified position of the seat.

A control method according to an embodiment of the present disclosure is performed by a control apparatus and includes:
receiving, from a wearable terminal worn by at least one passenger boarding a mobile object, biological information of the at least one passenger;
checking whether the at least one passenger has a sign of infection of a predetermined infectious disease based on the received biological information;
identifying a position of a seat for a suspected infected person for whom the sign has been detected among the at least one passenger; and
controlling air conditioning at the identified position of the seat.

According to an embodiment of the present disclosure, technology related to the control of vehicle air conditioning is improved.

### BRIEF DESCRIPTION OF THE DRAWINGS

In the accompanying drawings:

FIG. 1 is a block diagram illustrating an example of a schematic configuration of a control system according to an embodiment of the present disclosure; and

FIG. 2 is a sequence diagram illustrating an example of operations of the control system.

### DETAILED DESCRIPTION

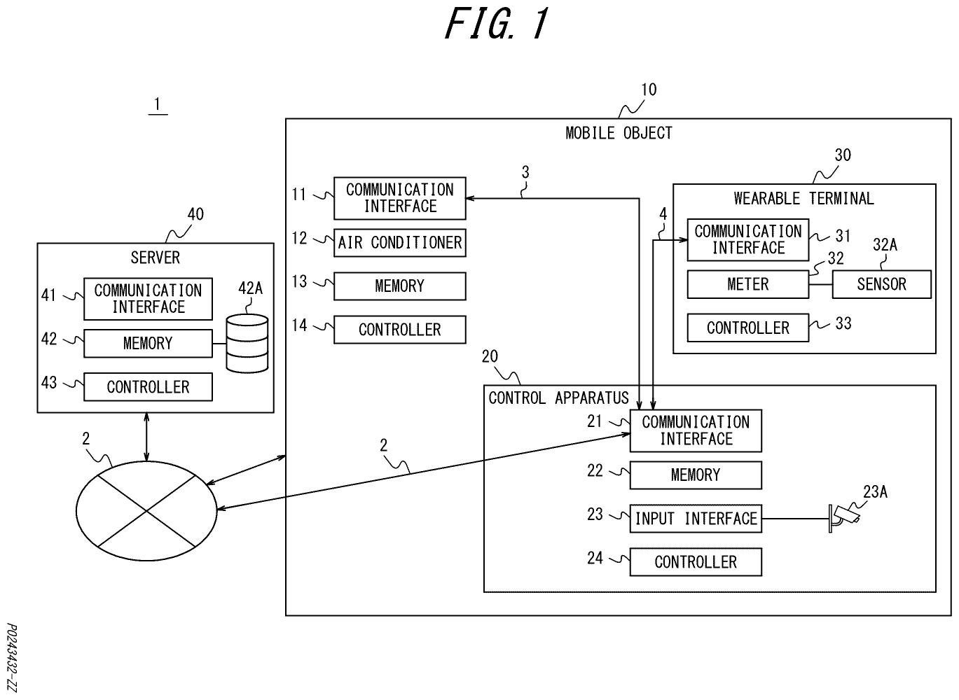

Hereinafter, an embodiment of the present disclosure will be described.

<Outline of Embodiment>An outline of a control system 1 according to the embodiment of the present disclosure will be described with reference to FIG. 1. The control system 1 includes a mobile object 10, a control apparatus 20, a wearable terminal 30, and a server 40. The mobile object 10, the control apparatus 20, and the server 40 are connected to the communicably via a network 2 (referring to the Internet). The control apparatus 20 may be able to communicate with the mobile object 10 by wire through an in-vehicle network 3 such as CAN (Controller Area Network). Furthermore, the control apparatus 20 is connected (paired) to the wearable terminal 30 worn by the passenger of the mobile object 10 via a short-range wireless network 4 using short-range wireless communication (e.g., Bluetooth® (Bluetooth is a registered trademark in Japan, other countries, or both)) to the communicably.

The mobile object 10 is, for example, an automobile that carries passengers (hereafter referred to as “passengers”), but it may also be a passenger aircraft or a passenger ship. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these.

The control apparatus 20 is a computer that controls the air conditioning inside the mobile object 10.

The wearable terminal 30 is a terminal apparatus worn by the passenger of the mobile object 10, such as a smartwatch, but may also be a terminal apparatus worn on various parts of the human body.

The server 40 is a computer owned by the operator that operates the mobile object 10.

### (Configuration of Mobile Object)

As illustrated in FIG. 1, the mobile object 10 includes a communication interface 11, an air conditioner 12, a memory 13, and a controller 14.

The communication interface 11 includes both a communication interface for wireless connection to the network 2 and a communication interface for wired connection to the in-vehicle network 3 such as CAN. The communication interface for connecting to the network 2 is compliant with mobile communication standards, such as the 4th generation (4G) standard or the 5th generation (5G) standard, for example, but is not limited to these, and may be compliant with any communication standard.

The air conditioner 12 includes equipment to adjust the temperature, humidity, air purification, and airflow inside the passenger cabin of the mobile object 10.

The memory 13 includes one or more memories. The memories are, for example, semiconductor memories, magnetic memories, optical memories, or the like, but are not limited to these. The memory 13 stores any information used for operations of the mobile object 10.

The controller 14 includes at least one processor, at least one programmable circuit, at least one dedicated circuit, or a combination of these. The controller 14 controls operations of the entire mobile object 10.

### (Control Apparatus Configuration)

As illustrated in FIG. 1, the control apparatus 20 includes a communication interface 21, a memory 22, an input interface 23, and a controller 24.

The communication interface 21 includes a communication interface for wireless connection to the network 2, a communication interface for wired connection to the in-vehicle network 3, and a communication interface for wireless connection to the short-range wireless network 4. The communication interface connecting to the network 2 corresponds to a mobile communication standard, for example. In the present embodiment, the control apparatus 20 communicates with the mobile object 10 and the server 40 via the network 2. The control apparatus 20 may also communicate with the mobile object 10 via the in-vehicle network 3. Furthermore, the control apparatus 20 is wirelessly connected (paired) with the wearable terminal 30 via the short-range wireless network 4.

The memory 22 includes one or more memories. The memories included in the memory 22 may each function as, for example, a main memory, an auxiliary memory, or a cache memory. The memory 22 stores any information used for operations of the control apparatus 20. The memory 22 may store a system program, an application program, a database, and the like.

The input interface 23 includes a camera 23A that captures images (moving images or still images).

The controller 24 includes at least one processor, at least one programmable circuit, at least one dedicated circuit, or a combination of these. The controller 24 controls operations of the entire control apparatus 20.

### (Composition of Wearable Terminal)

As illustrated in FIG. 1, the wearable terminal 30 includes a communication interface 31, a meter 32, and a controller 33.

The communication interface 31 includes a communication interface for wireless connection to the short-range wireless network 4 by Bluetooth or other means. The wearable terminal 30 is wirelessly connected (paired) to the control apparatus 20 via the short-range wireless network 4.

The meter 32 includes one or more sensors 32A that measure human biological information. Biological information includes, but is not limited to, heart rate, pulse rate, blood pressure, respiratory rate, body temperature, blood oxygen saturation, cardiac potentials, brain waves, skin temperature, heartbeat intervals, brain wave intervals, physical activity level, and posture of the passenger. The one or more sensors 32A include, but are not limited to, heart rate sensors, blood pressure sensors, respiration sensors, temperature sensors, blood oxygen saturation sensors, ECG sensors, motion sensors, etc.

The controller 33 includes at least one processor, at least one programmable circuit, at least one dedicated circuit, or a combination of these. The controller 33 controls the operations of the entire wearable terminal 30.

### (Configuration of Server)

As illustrated in FIG. 1, the server 40 includes a communication interface 41, a memory 42, and a controller 43.

The communication interface 41 includes at least one communication interface for connecting to the network 2. The communication interface is compliant with, for example, but not limited to, a mobile communication standard, a wired local area network (LAN) standard, or a wireless LAN standard, and may be compliant with any appropriate communication standard. The server 40 communicates with the control apparatus 20 via the communication interface 41 and the network 2.

The memory 42 includes one or more memories. The memories included in the memory 42 may each function as, for example, a main memory, an auxiliary memory, or a cache memory. The memory 42 stores any information used for operations of the server 40. For example, the memory 42 may store a system program, an application program, a database 42A, and the like. The database 42A stores identification information of the passenger himself/herself and an image of a facial photograph associated with the identification information, which the passenger of the mobile object 10 registered at the time of ticket purchase, etc.

The controller 43 includes at least one processor, at least one programmable circuit, at least one dedicated circuit, or a combination of these. The controller 43 controls operations of the entire server 40.

### (Flow of Operations of Control Apparatus)

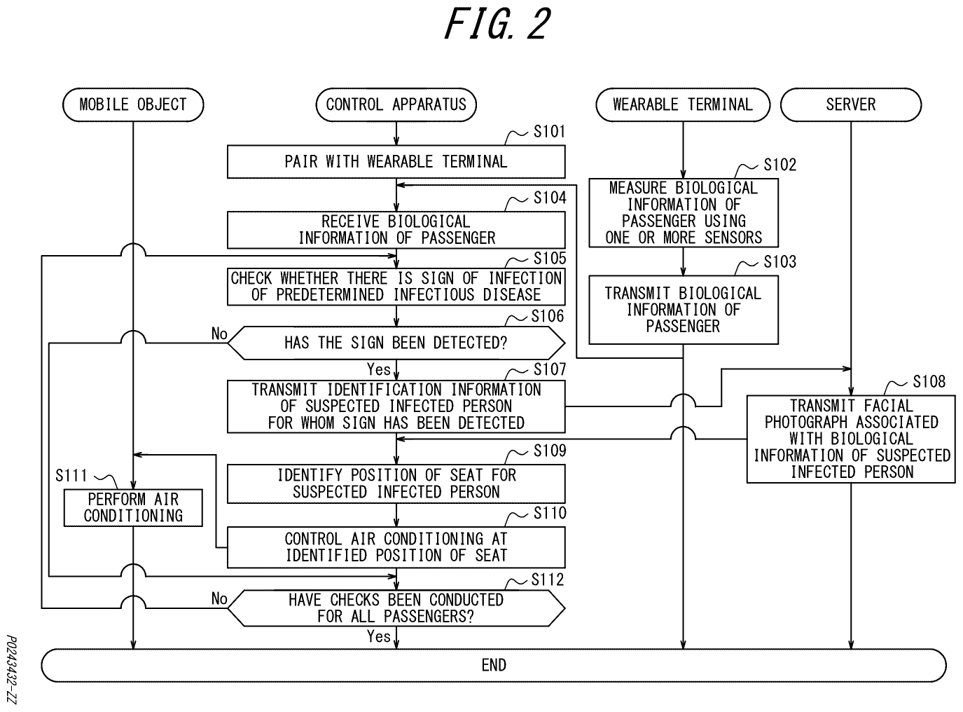

FIG. 2 is a sequence diagram illustrating example operations of the control system 1. Operations of the control apparatus 20 according to the present embodiment will be described with reference to FIG. 2.

S101: The controller 24 is communicably connected (paired) with the wearable terminal 30 worn by a passenger Px boarding the mobile object 10 via the communication interface 21 and the communication interface 31.

The control apparatus 20 is paired with the wearable terminal 30, for example, by Bluetooth. However, communication methods are not limited to Bluetooth. The pairing of both apparatuses enables the controller 24 to receive the biological information of the passenger Px boarding the mobile object 10. There are one or more passengers Px.

S102-S103: The meter 32 of the wearable terminal 30 measures the biological information of the passenger Px by one or more built-in sensors 32A and transmits the measured biological information to the control apparatus 20.

S104: The controller 24 receives biological information of the passenger Px from the wearable terminal 30.

The biological information includes identification information of the passenger Px wearing the wearable terminal 30, and data on heart rate, pulse rate, blood pressure, respiratory rate, body temperature, blood oxygen saturation, cardiac potentials, brain waves, skin temperature, heartbeat intervals, brain wave intervals, physical activity level, and/or posture of the passenger Px that is measured by the wearable terminal 30. The identification information of the passenger Px is, for example, address, name, and user ID.

S105-S106: The controller 24 checks whether the passenger Px has a sign of infection of a predetermined infectious disease based on the received biological information of the passenger Px. If a sign s has been detected, go to S107; if a sign s has not been detected, go to S112.

Infectious diseases include (i) aerosol, (ii) droplet, (iii) contact, and (iv) airborne infections. Aerosol infection is caused by inhalation of aerosols containing airborne viruses. Droplet infection occurs when droplets containing the virus adhere to exposed mucous membranes such as the mouth, nose, and eyes. Contact infection is caused by direct contact with droplets containing the virus or by touching exposed mucous membranes with fingers that have touched the surface of a virus-covered object. Airborne transmission is when viruses or bacteria are released into the air by coughing or sneezing, entrapped in fine saliva or airway secretions, and infect people within a distance of about 1 meter.

In this disclosure, a new type of coronavirus infection will be used as an example. The main routes of transmission of novel coronavirus infection are considered to be (i) aerosol infection, (ii) droplet infection, and (iii) contact infection as described above. Hereinafter in this disclosure, a passenger for whom the sign of infection of a predetermined infectious disease has been detected among the passenger Px is referred to as a suspected infected person Py. In such an infection route, aerosols or droplets containing the virus are exhausted into the air, exposing passengers Px seated around the suspected infected person Py to the risk of infection.

A sign s is, for example, higher or lower than normal body temperature, blood pressure, blood oxygen saturation (SpO2), pulse rate, or respiratory rate, in the case of novel coronavirus infection. For example, if the body temperature is equal to or higher than 37.5° C. and the SpO2 is less than 96%, the patient may be judged to have signs s of new-type coronavirus infection, but the criteria for judgment are not limited to this.

S107: The controller 24 transmits the identification information contained in the biological information of the suspected infected person Py for whom the sign s has been detected among the passenger Px, to the server 40.

S108: The controller 43 of the server 40 transmits to the control apparatus 20 the facial photograph of the suspected infected person Py obtained by searching the database 42A for an image using the identification information of the suspected infected person Py whose sign s has been detected as the search condition.

S109: The controller 24 identifies the position of the seat for the suspected infected person Py for whom the sign s has been detected.

The controller 24 acquires a facial photograph of the suspected infected person Py from the server 40 and identifies the position of the seat for the suspected infected person Py by comparing the acquired facial photograph of the suspected infected person Py with the facial images of one or more passengers Px in the image captured by the camera 23A inside the mobile object 10.

S110: The controller 24 controls the air conditioning at the identified position of the seat.

Controlling of the air conditioning includes exhausting the air around the seat for the suspected infected person Py out of the mobile object 10 and/or generating an air curtain around the seat for the suspected infected person Py. The controller 24 transmits to the mobile object 10 the identified position of the seat and the method of air conditioning control to be performed.

S111: The controller 14 of the mobile object 10 causes the air conditioner 12 to perform air conditioning at the identified position of the seat based on the air conditioning control method transmitted from the controller 24.

The air conditioner 12 of the mobile object 10 includes equipment to adjust the airflow inside the cabin of the mobile object 10. The air conditioner 12 exhausts air around the seat for the suspected infected person Py out of the mobile object 10 and/or generates an air curtain around the seat of the suspected infected person Py, as required by the controller 24. This reduces the risk of aerosols containing viruses or droplets containing viruses that are exhausted into the air reaching the passengers Px seated around the suspected infected person Py.

S112: The controller 24 confirms whether checks for all passengers Px have been conducted. If checks for all passengers Px have been conducted, the air conditioning control is terminated; if check for all passengers Px have not been conducted, the system returns to S105 and continues checking the unchecked passengers Px for signs of infection with the predetermined infectious disease until checks for all passengers Px have been completed.

As described above, the control apparatus 20 according to the present embodiment checks whether the passenger Px boarding the mobile object 10 has a sign s of infection of a predetermined infectious disease based on biological information of the passenger Px that has been received from the wearable terminal 30 worn by the passenger Px, identifies a position of a seat for the suspected infected person Py for whom the sign s has been detected among the passenger Px, and controls air conditioning at the identified position of the seat.

According to such a configuration, the position of the seat for the suspected infected person Py for whom the sign s of infection of a predetermined infectious disease has been detected is identified, and the air conditioning at the identified position of the seat is controlled. Thus, even if a passenger Px boarding the mobile object 10 is unaware that a suspected infected person Py is seated around him or her, the air conditioning at the position of the seat for the suspected infected person Py is automatically controlled. Thus, technology related to the control of vehicle air conditioning is improved in that the risk of a passenger Px boarding a mobile object contracting a predetermined infectious disease is reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which a general purpose computer functions as the control apparatus 20 according to the above embodiment can also be implemented. Specifically, a program in which processes for realizing the functions of the control apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A control system comprising:
a wearable terminal to be worn by at least one passenger boarding a mobile object, the wearable terminal being configured to:
measure biological information of the at least one passenger using one or more built-in sensors; and
transmit the measured biological information to a control apparatus; and
the control apparatus configured to:
check whether the at least one passenger has a sign of infection of a predetermined infectious disease based on the biological information of the at least one passenger, which has been received from the wearable terminal;
identify a position of a seat for a suspected infected person for whom the sign has been detected among the at least one passenger; and
control air conditioning at the identified position of the seat.

2. A control apparatus comprising a controller configured to:
check whether at least one passenger boarding a mobile object has a sign of infection of a predetermined infectious disease based on biological information of the at least one passenger that has been received from a wearable terminal worn by the at least one passenger;
identify a position of a seat for a suspected infected person for whom the sign has been detected among the at least one passenger; and
control air conditioning at the identified position of the seat.

3. The control apparatus according to claim 2, wherein the biological information includes identification information of the at least one passenger, who wears the wearable terminal, and data on heart rate, pulse rate, blood pressure, respiratory rate, body temperature, blood oxygen saturation, cardiac potentials, brain waves, skin temperature, heartbeat intervals, brain wave intervals, physical activity level, and/or posture of the at least one passenger that is measured by the wearable terminal.

4. The control apparatus according to claim 2, wherein controlling of the air conditioning includes exhausting air around the seat for the suspected infected person out of the mobile object and/or generating an air curtain around the seat for the suspected infected person.

5. The control apparatus according to claim 3, wherein the controller is configured to:
acquire a facial photograph of the suspected infected person obtained by searching database for an image using identification information of the suspected infected person as a search condition; and
identify the position of the seat for the suspected infected person by comparing the acquired facial photograph of the suspected infected person with a facial image of the at least one passenger in an image captured inside the mobile object.

6. A control method performed by a control apparatus, the control method comprising:
receiving, from a wearable terminal worn by at least one passenger boarding a mobile object, biological information of the at least one passenger;
checking whether the at least one passenger has a sign of infection of a predetermined infectious disease based on the received biological information;
identifying a position of a seat for a suspected infected person for whom the sign has been detected; and
controlling air conditioning at the identified position of the seat.
